(19) United States
(12) Patent Application Publication
(10) Pub. No.: US 2006/0242006 A1
(43) Pub. Date: Oct. 26, 2006

(54) Method of Fee Recovery for Free Cellular Service Through Advertising

(76) Inventor: Louis Oliver Hogan, HAYWARD, CA (US)

Correspondence Address: LOUIS OLIVER HOGAN, 24249 2ND ST., HAYWARD, CA, 94541, US

(21) Appl. No.: 10/907,245

(22) Filed: Mar. 25, 2005

(51) Int. Cl. G07G 1/14

(52) U.S. Cl. 705/14

(57) ABSTRACT

The user of a cell phone service must listen and respond to advertisement in advance of placing a call, whereupon a portion of the advertising revenues paid to the cell phone service are used to pay for the user's access fee to use the cell phone service, resulting in incentivized cell phone usage combined with a highly effective advertising delivery system. Additionally, the user may make purchases and have a portion of the revenues used to pay the user's access fee. Additionally, the user may identify themselves on alternate equipment and use the benefits of the incentivized usage telephonic system on the alternate equipment, including another system.

### FIELD OF THE INVENTION

The invention relates to a system whereby the user of a cell phone service must listen and respond to advertisement in advance of placing a call, whereupon a portion of the advertising revenues paid to the cell phone service are used to pay for the user's access fee to use the cell phone service, resulting in incentivized cell phone usage combined with a highly effective advertising delivery system. Additionally, the user may make purchases and have a portion of the revenues used to pay said user's access fee. Additionally, the user may identify themselves on alternate equipment and use the benefits of the incentivized usage telephonic system on the alternate equipment, including another system.

### BACKGROUND OF THE INVENTION

Advertising services are confronted with a serious issue: it used to take 3 exposures of an end user to an advertisment to get a response. Because of the overflowing quantity of advertising surrounding the end user in 2005, one survey has measured a need for 93 exposures to generate a buying response. On the internet, the most common activity is advertising, and it's what people want the least. People are ignoring advertising.

In the past, there have been offers of free computers and free online access in order for the advertising services to expose people to advertisements. The cost of the computers and online access made it financially disadvantageous to continue giving away free computers.

People want cell phones. Cell phones offer increased safety, earning power, and socialization for the people who use them. Unfortunately, cell phone service is an ongoing expense that not everyone can afford. Due to the expense, many people default on their cell phone contracts, which negatively affects their credit, and thus their ability to participate in enterprise. These defaults also cause losses to the cellular service provider.

People want a stable cell phone number so they can be found, even if they can't afford to keep a cell phone contract. A stable number and ready communication helps people stay connected and productive in today's society. A loss of a cell phone contract results in the loss of a number.

U.S. Pat. No. 6,839,556 of Malackowski, et al. discloses a method for wireless delivery of targeted messages to prospective consumers with the access fee payed by the advertiser, but only for access to the advertisement, and only upon demand of said user for said advertisement.

### SUMMARY OF THE INVENTION

The purpose is twofold: first, free communications service, and second, a new, extremely effective advertising channel. The advantages are: free communication or cellphone service, a method to advertise to a captive audience, an interactive terminal to insure a response from the audience, ability to individualize or customize the service to the audience on a one-for-one basis. An additional advantage is that if a user can not afford to maintain a fee-based service, the user may go to an incentive based service and maintain a stable cellphone number. In addition, there's no reason an incentive based service can't be provided over the same networks as fee-based services. If a user allows their payments for month-to-month service to lapse, their communications service provider can automatically switch them to incentive based service and continue to collect revenue for phone usage. In addition, much larger revenues can be generated if the cell phone is able to conveniently consummate purchases. Also, if an account is maintained by the vendor of incentive based service, it can be used to pay for individual calls made on equipment connected to any system, similarly to phone card service.

There are somewhat similar advertising concepts on the internet, but they involve the ability to click a box and move on, or perhaps a time-delay-before-click while a box is displayed on the screen of your computer. It's almost habit to ignore the content of such advertising. Then there's conventional advertising over the phone. The user may hang up without loss of anything but the offer the advertiser was presenting. There's no real incentive to hear the advertiser out. With incentivized service, the user is pre-incentivized, that is, they know they have to pay attention, and have agreed to do so before the advertiser ever makes contact with them. I don't believe there is any similar effective form of pre-incentivized phone advertising.

### Preferred Embodiment—Operation

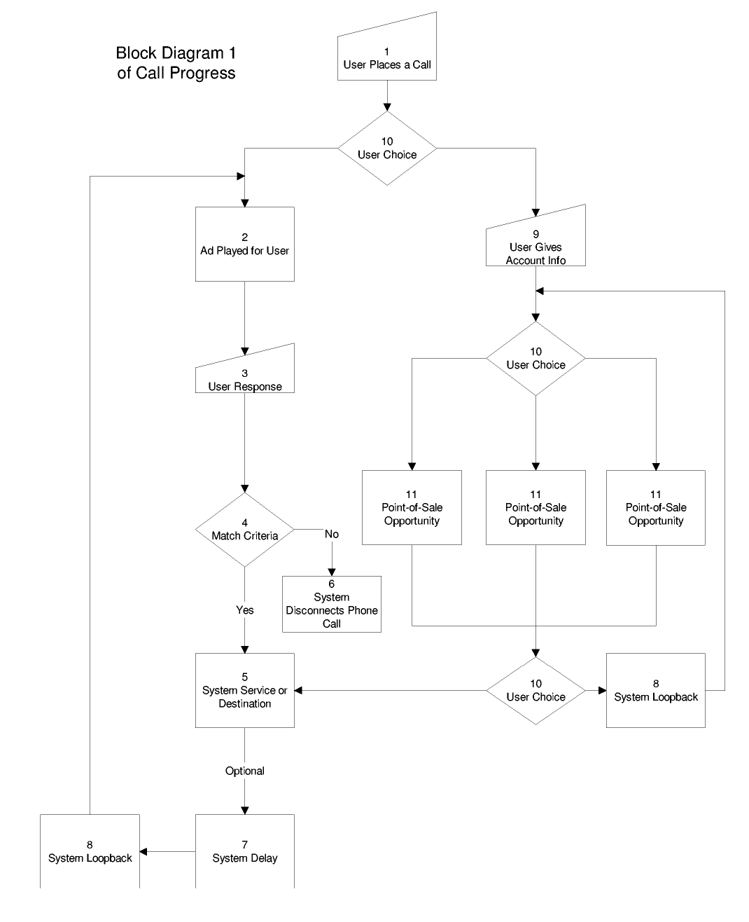

The process shown in FIG. 1 is the logic flow for the progress of a telephone call placed according to this invention.

Initially, a user PLACES A CALL 1 from a terminal of a programmable telephonic system intended to access an available SERVICE OR DESTINATION 5.

Said system stores and may access a multiplicity of advertisements from a multiplicity of advertisers, and is capable of reproducing an AD PLAYED FOR USER 2 at said terminal.

User is able to generate a RESPONSE 3 from a keyboard or microphone on said terminal.

Optionally, said system is able to compare RESPONSE 3 with MATCH CRITERIA 4.

Said system is able to DISCONNECT TELEPHONE CALL 6 or give access to SERVICE OR DESTINATION 5.

Optionally, said system is able to execute a DELAY 7 and a LOOPBACK 8 as program steps.

### Preferred Embodiment—Operation

The process shown in FIG. 1 is the logic flow for the progress of a telephone call placed according to this invention. Initially, a user PLACES A CALL 1 from a terminal of a programmable telephonic system intended to access an available SERVICE OR DESTINATION 5. Next, said system reproduces a one or more of a multiplicity of advertisements from a multiplicity of advertisers, as an AD PLAYED FOR USER 2. Optionally, said user is required to generate a RESPONSE 3. If said optional RESPONSE 3 does not match said system's optional MATCH CRITERIA 4, said system DISCONNECTS TELEPHONE CALL 6. Examples of said system's optional criteria may include keypresses on said terminal or audible responses to said terminal at specified times. If said optional RESPONSE 3 does match said system's MATCH CRITERIA 4, or if said optional RESPONSE 3 is not used, then said system connects said user to said SERVICE OR DESTINATION 5. Optionally occurring and optionally recurring, after a DELAY 7, said system will LOOPBACK 8 and reproduce an additional event, AD PLAYED FOR USER 2. Optionally, said user is required to make a RESPONSE 3. If said optional RESPONSE 3 does not match said system's optional MATCH CRITERIA 4, said system DISCONNECTS TELEPHONE CALL 6. If said optional RESPONSE 3 does match said system's optional MATCH CRITERIA 4, or if said optional RESPONSE 3 is not used, said system allows said user to continue to access SERVICE OR DESTINATION 5.

Said advertiser is billed for advertising on said system, and a portion of said billing is used to defray the cost of said usage of said system for said user.

Example: Fred keys in a number on his cell phone, which specifies a SERVICE OR DESTINATION 5, and hits “send”. PLACES A CALL 1. The cellular service provider, “Blip-Phone”, receives the request on its automated equipment and responds with an advertisement for “Skrippy Scream Donuts”. AD PLAYED FOR USER 2. During the advertisement, Fred is requested to repeat, “I scream for donuts!”, or press the 3 key. The advertisement script allows for a five second response window after making this request. MATCH CRITERIA 4. Fred, who really wants to make this call, chooses to push the 3 key within 3 seconds. RESPONSE 3. The computer at Blip-Phone compares Fred's RESPONSE 3 with its MATCH CRITERIA 4 and decides that Fred has met the MATCH CRITERIA 4. The computer connects Fred with SERVICE OR DESTINATION 5. Ten minutes into Fred's phone conversation, DELAY 7, the computer at Blip-Phone sends Fred a quiet pleasant beep as a 5 second warning, and then, LOOPBACK 8, plays an advertisement for “Slippy Stream Vulcanized Tires”. AD PLAYED FOR USER 2. This advertisement asks Fred to press the “star” key. MATCH CRITERIA 4. When Fred does so RESPONSE 3, and the computer at Blip-Phone determines that once again, Fred has satisfied the MATCH CRITERIA 4 with his RESPONSE 3, and allows him to continue his phone conversation for another five minutes, at which time Fred disconnects. Blip-phone has a billing structure that counts “hits”, and since Fred experienced an “Americad” advertisement hit and a “Sell-Phone” advertisement hit, Blip-phone bills each of these clients for a “hit”, resulting in a revenue profit of $0.05 at the bottom line after the expense of connecting Fred.

### Purchase Alternative—Description

The process shown in FIG. 1 is the logic flow for the progress of a telephone call placed according to this invention.

Initially, a user PLACES A CALL 1 from a terminal of a programmable telephonic system.

Said user inputs unique ACCOUNT INFORMATION 9.

Said system stores and may access a multiplicity of POINT-OF-SALE OPPORTUNITY 11 from a multiplicity of vendors, and is capable of reproducing said opportunity at said terminal.

USER CHOOSE 10 indicates where said user is given the opportunity to make a choice.

### Purchase Alternative—Operation

24 The process shown in FIG. 1 is the logic flow for the progress of a telephone call placed according to this invention.

25 Initially, a user PLACES A CALL 1 from a terminal of a programmable telephonic system intended to access an available POINT-OF-SALE OPPORTUNITY 11. Said user inputs unique ACCOUNT INFORMATION 9.

26 Said system stores and may access a multiplicity of opportunities from a multiplicity of vendors, and is capable of reproducing a POINT-OF-SALE OPPORTUNITY 11 at said terminal. User may CHOOSE 10 a particular POINT-OF-SALE OPPORTUNITY 11. User executes said opportunity, and is then given an opportunity to CHOOSE 10 another POINT-OF-SALE OPPORTUNITY 11 or access to SERVICE OR DESTINATION 5. A portion of the profit on said opportunity is remunerated to said user's account, as credit available for said access on said system, or for other use.

### Conclusions, Ramifications, and Scope

Accordingly, it can be seen that this invention puts in place the benefits of free cell phone or other phone service for the end user, combined with an advertising channel which, by its sequential nature, requires the user to pay attention to the content of the advertisement.

Although the description above contains many specificities, these should not be construed as limiting the scope of the invention but as merely providing illustrations of some of the presently preferred embodiments of this invention. Various other embodiments and ramifications are possible within its scope. For example, it would be possible for a month to month cell phone service provider to automatically switch users over to this advertising based system if the user did not renew, with the twin benefits of the provider continuing to receive revenue from cell phone usage, and the user not losing their cell phone number or ability to communicate. Cell phone technology is an ideal way to advertise, because of its inherent regionality—that is, ads could be tailored to the needs of a neighborhood, rather than having to be appropriate (and priced for) the needs of a large geographical area. Similar ads could be placed over large areas with appropriate dialect, offers, and outlet locations offered locally thus increasing the effectiveness of wide area advertising as well. In addition, advertising is offered to individually identified users, making it possible and practical to have a series of ads that would offer considerable educational content, not just a hyperventilated sales pitch, thus increasing the marketing effectiveness of vendors with complicated or obscure products. In addition, various advertising providers could put out competing products, which could be chosen by the user, thus separating the art and science of marketing from the heavy technical and infrastructure investment of communications, and also allowing a healthy competition for effective advertising products from the advertising vendors.

In addition, sales could be consummated using this system, with a portion of the profit revenues being used as an account to fund system access. Also, this system access need not be limited to the system where the revenues were generated, as the value of the account could be used to pay for access on another phone system through automatic payments or contracts.

Thus the scope of the invention should be determined by the appended claims and their legal equivalents, rather than by the examples given.

What is claimed is:

1. A method of exposing advertising content to end users by using a telephonic communicating system comprising:
presenting advertising content to a user over a telephonic communication system prior to allowing said user to access services on said system, and
creating incentive with said user to participate in absorbing said advertising content by remunerating said user from revenues customarily paid for advertising access.

2. The method of claim 1 wherein access of said user is contingent upon a process of requiring and confirming specific responses from said user to be input into said system.

3. The method of claim 1 wherein said user may choose among a plurality of types of said advertising content.

4. The method of claim 1 wherein instead of advertising content, there is instructional content.

5. The method of claim 1 wherein the services user accesses are monitored for content.

6. The method of claim 1 wherein the services user accesses are automatically parsed or recognized for content.

7. The method of claim 1 wherein remuneration to said user is a partial or total reduction of the customary fees that would usually be charged said user for access to services on said system.

8. The method of claim 1 wherein the identity of the user may be established by specific responses which said user inputs into said system, thus linking remuneration to the user, rather than linking remuneration to particular equipment in the system.

9. A method of offering a Point-Of-Sale opportunity to end users by using a telephonic communicating system comprising:
presenting said opportunity to a user over a telephonic communication system prior to allowing said user to access services on said system, and
creating incentive with said user to use said opportunity to make a purchase by remunerating said user from revenues generated by profit from consumated purchases.

10. The method of claim 9 wherein access of said user is contingent upon a process of requiring and confirming specific responses from said user to be input into said system.

11. The method of claim 9 wherein said user may choose among a plurality of types of said opportunities.

12. The method of claim 9 wherein remuneration to said user is a partial or total reduction of the customary fees that would usually be charged said user for access to services on said system.

13. The method of claim 9 wherein the identity of the user may be established by specific responses which said user inputs into said system, thus linking said opportunity to the user, rather than linking said opportunity to particular equipment in the system.

14. A method of allowing a user to access an incentive based telephonic communications system from an other system's equipment, which would allow said user to access the services of said other system and use remunerations generated on said incentive based system to pay the cost of access to services on said other system.
